(19) United States
(12) Patent Application Publication
(10) Pub. No.: US 2025/0106613 A1
(43) Pub. Date: Mar. 27, 2025

(54) LINK-LEVEL ROAMING IN A WIRELESS NETWORK

(71) Applicant: NXP USA, Inc., AUSTIN, TX (US)

(72) Inventors: Liwen Chu, San Ramon, CA (US); Kiseon Ryu, San Diego, CA (US); Huizhao Wang, San Jose, CA (US); Hongyuan Zhang, Fremont, CA (US)

(21) Appl. No.: 18/969,753

(22) Filed: Dec. 5, 2024

Related U.S. Application Data
(63) Continuation-in-part of application No. 18/644,895, filed on Apr. 24, 2024.
(60) Provisional application No. 63/606,724, filed on Dec. 6, 2023.
(60) Provisional application No. 63/498,135, filed on Apr. 25, 2023.

(51) Int. Cl. H04W 8/14; H04W 76/15

(52) U.S. Cl. CPC H04W 8/14; H04W 76/15

(57) ABSTRACT

Non-access point (non-AP) multi-link device (MLD) roaming among a serving AP MLD and a target AP MLD of a roaming domain is disclosed. Links are set up from the non-AP MLD to the serving AP MLD. The non-AP MLD affiliated with the roaming domain initiates a link-level roaming setting up a link to the target AP MLD, wherein respective links are set up from the non-AP MLD to the serving AP MLD and target AP MLD. A type of links from the non-AP MLD to the serving AP MLD and target AP MLD is announced and the non-AP MLD terminates all links between the non-AP MLD and the serving AP MLD where the non-AP MLD has links set up only with the target AP MLD to complete the link-level roaming.

### CROSS-REFERENCE TO RELATED APPLICATIONS

This application is a continuation-in-part of application Ser. No. 18/644,895 entitled “Multi-Link Device (MLD) Level Roaming and Link Level Roaming in a Wireless Network” which was filed Apr. 24, 2024 and which claims the benefit of U.S. Provisional Patent Application Ser. No. 63/498,135 entitled “MLD Level Roaming and Link Level Roaming” filed Apr. 25, 2023, the contents of which are incorporated herein by reference in its entirety. This application is also entitled to the benefit of U.S. Provisional Patent Application Ser. No. 63/606,724, titled “Link Level Roaming” which was filed Dec. 6, 2023, the contents of which are incorporated herein by reference in its entirety.

### BACKGROUND

A roaming domain with access point multi-link devices (AP MLDs) positioned at different locations in a wireless network facilitates roaming by a non-AP MLD within an area covered by the AP MLDs. By making the area large, a chance of the non-AP MLD transitioning from an AP MLD of one roaming domain to an AP MLD of another roaming domain is reduced. After a non-AP MLD sets up the association with the roaming domain through the links of one AP MLD (serving AP MLD), the non-AP MLD can seamlessly roam from the serving AP MLD to another AP MLD (target AP MLD) without reassociation and a state 4 operation is maintained (class 3 frame exchanges such as data frames, management frames, and control frames are continued without reassociation). The non-AP MLD has already made an authentication and association with the roaming domain through an AP MLD affiliated with the roaming domain. The roaming as one option then continues with the non-AP MLD keeping one or more links with the serving AP MLD and setting up link(s) to a target AP MLD affiliated with the roaming domain so that links are set up to both the target AP MLD and serving AP MLD which is allowed only after a distributed system (DS) mapping change of the non-AP MLD is finished and during a temporary roaming stage. During the temporary roaming stage, the non-AP MLD can do the data frame exchanges with the serving AP MLD and the target AP MLD. Then, the non-AP MLD terminates remaining link(s) set up with the serving AP MLD and sets up zero, one, or more additional links to the target AP MLD so that links are only set up to the target AP MLD affiliated with the roaming domain. The roaming as another option starts with the non-AP MLD deleting all its links with the serving AP MLD and setting up all the links to a target AP MLD affiliated with the roaming domain so that the non-AP MLD's frame exchanges with both the target AP MLD and serving AP MLD are not allowed even during a temporary roaming stage. Then, the non-AP MLD does the frame exchanges with the target AP MLD only since the links of the non-AP MLD are only set up to the target AP MLD affiliated with the roaming domain.

### BRIEF DESCRIPTION OF DRAWINGS

FIG. 1 illustrates example roaming operations in a multi-link communications system in accordance with one or more embodiments.

FIG. 2 is an example of communications associated with performing link-level roaming in the multi-link communications system based a non-AP MLD being temporarily associated with two AP MLDs by a non-simultaneous transmit receive (NSTR) link pair in accordance with one or more embodiments.

FIG. 3 is another example of communications associated with performing link-level roaming in the multi-link communications system based on the non-AP MLD being temporarily associated with two AP MLDs by a non-simultaneous transmit receive (NSTR) link pair in accordance with one or more embodiments.

FIG. 4 is an example of communications associated with performing link-level roaming in the multi-link communications system based the non-AP MLD being associated with two AP MLDs which operate as a multi-link signal radio (MLSR) or enhanced MLSR (eMLSR) pair in accordance with one or more embodiments.

FIG. 5 illustrates in more detail an example frame exchange between the non-AP MLD and two AP MLDs during the link-level roaming in accordance with one or more embodiments.

FIG. 6 describes example uplink (UL) communication options for link-level roaming in the multi-link communications system by the non-AP MLD associated with AP MLDs in accordance with one or more embodiments.

FIG. 7 describes example downlink (DL) communication options for link-level roaming in the multi-link communications system by the non-AP MLD being associated AP MLDs in accordance with one or more embodiments.

FIG. 8 is an example of signaling by the non-AP MLD to perform a roaming operation in the multi-link communications system in accordance with one or more embodiments.

FIG. 9 is an example flow chart of functions associated with link-level roaming in the multi-link communication system in accordance with one or more embodiments.

Throughout the description, similar reference numbers may be used to identify similar elements.

### DETAILED DESCRIPTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment”, “an embodiment”, “an example”, or similar language means that a particular feature, structure, or characteristic described in connection with the indicated embodiment is included in at least one embodiment of the present invention. Thus, the phrases “in one embodiment”, “in an embodiment”, “an example”, and similar language throughout this specification may, but do not necessarily, all refer to the same embodiment.

Several aspects of the disclosed WiFi system will now be presented with reference to various apparatuses and techniques. These apparatuses and techniques will be described in the following detailed description and illustrated in the accompanying drawings by various blocks, modules, components, circuits, steps, processes, algorithms, and/or the like (collectively referred to as “elements”). These elements may be implemented using hardware, software, or combinations thereof. Whether such elements are implemented as hardware or software depends upon the particular application and design constraints imposed on the overall system.

Embodiments disclosed herein are directed to a non-access point (non-AP) multi-link device (MLD) roaming among AP MLDs affiliated with a roaming domain at a link-level where during a roaming stage of a non-AP MLD (i.e., STA MLD), the non-AP MLD can do class 3 frame exchanges with the serving AP MLD and the target AP MLD (the future serving AP MLD). The non-AP MLD associated with the roaming domain has set up links to a serving AP MLD and initiates a roaming by setting up at least one link to a target AP MLD while maintaining one or more links to the serving AP MLD and then terminating all links to the serving AP MLD and setting up additional links if required to the target AP MLD so that the non-AP MLD has only links to the target AP MLD. When the two links are established between the non-AP MLD with the serving AP MLD and target AP MLD and a type of links announced is not a simultaneous transmit receive (STR) link pair, i.e., one of a non-simultaneous transmit receive (NSTR) pair, a multi-link single radio (MLSR) pair, and enhanced MLSR (eMLSR) pair, only one PPDU is transmitted in one of the two links at a time based on a power save or a negotiated time wake time (TWT) where an STA of the non-AP MLD associated with only one of the two links is in a wake state, a multi-user (MU) request to send/clear to send (RTS/CTS) frame exchange on a link of the NSTR pair, or the non-AP MLD notifies the AP MLDs that the non-AP MLD cannot do simultaneous frame exchanges like the STR link pair during the temporary roaming. The frame exchange between the non-AP MLD and target AP MLD is performed after a frame exchange context and distributed system (DS) mapping change is finished and during the temporary roaming. The non-AP MLD and one or more of the AP MLD are arranged to communicate in an uplink and/or downlink direction and with only one physical layer protocol data unit (PPDU) transmitted in one of the two links at a time. In some embodiments, the roaming domain determines that the non-AP MLD transmits frames in an uplink (UL) direction to both of the AP MLDs or by a negotiation with the roaming domain and non-AP MLD after the DS mapping change is finished and during the temporary stage, with the non-AP MLD having links to the serving AP MLD and target AP MLD. In some embodiments, the UL frames are transmitted to only one AP MLD such as the target AP MLD after the DS mapping change is finished and during the temporary stage, with the non-AP MLD having links to the serving AP MLD and target AP MLD. In some embodiments, the roaming domain determines that both AP MLDs transmit frames to the non-AP MLD in a downlink (DL) direction after the DS mapping change is finished and during the temporary stage, with the non-AP MLD having links to the serving AP MLD and target AP MLD. In some embodiments, the roaming domain and non-AP MLD negotiate that both AP MLDs transmit frames with a downlink (DL) traffic identifier (TIDs) to the non-AP MLD after the DS mapping change is finished and during the temporary stage, with the non-AP MLD having links to the serving AP MLD and target AP MLD. In some embodiments, the roaming domain and non-AP MLD negotiate that both AP MLDs transmit frames with a downlink (DL) traffic identifier (TIDs) to the non-AP MLD not associated with a TID to link mapping after the DS mapping change is finished and during the temporary stage, with the non-AP MLD having links to the serving AP MLD and target AP MLD. In some embodiments, the roaming domain and non-AP MLD negotiate that both AP MLDs transmit frames with a downlink (DL) traffic identifier (TIDs) to the non-AP MLD based on a TID to link mapping after the DS mapping change is finished and during the temporary stage, with the non-AP MLD having links to the serving AP MLD and target AP MLD. In some embodiments, the roaming domain and non-AP MLD negotiate that the frames are transmitted by only one AP MLD, i.e., the target AP MLD, to the non-AP MLD after the DS mapping change is finished and during the temporary stage, with the non-AP MLD having links to the serving AP MLD and target AP MLD. Well known instructions, protocols, structures, and techniques have not been shown in detail in order not to obfuscate the description.

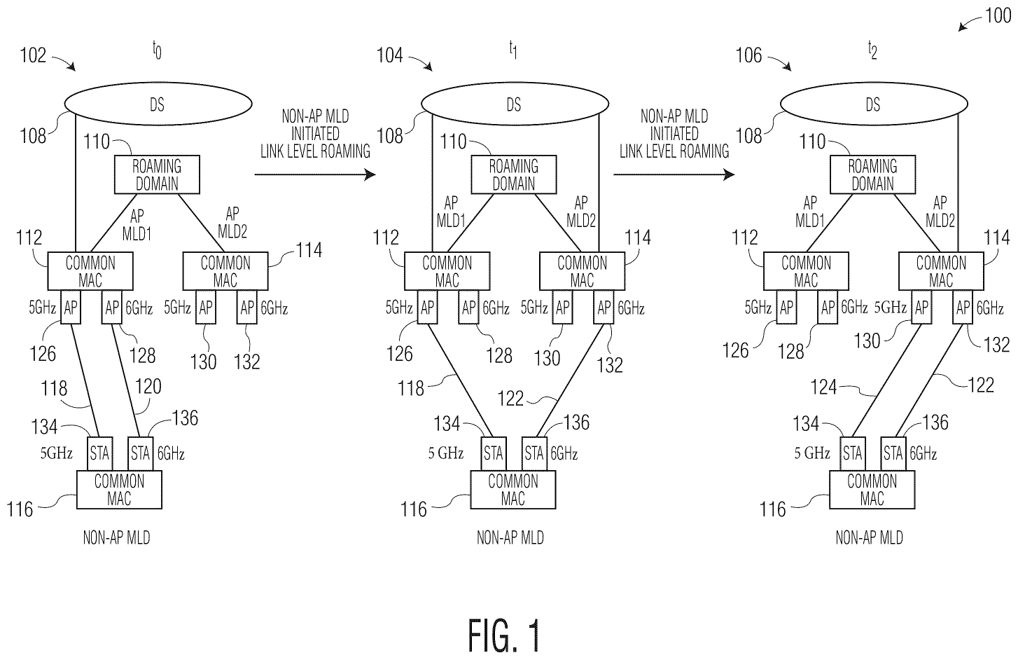

FIG. 1 illustrates an example roaming operation in a multi-link communications system 100 for wireless (e.g., WiFi) communications in accordance with one or more embodiments. In the embodiment shown in FIG. 1, the multi-link communications system 100 includes a roaming domain 110 which includes a number of different affiliated AP MLDs 112, 114 in different physical locations that operate together and each have a common medium access control (MAC) service access point (SAP) address. The multi-link communications system 100 also has a non-AP station (STA) MLD (non-AP MLD) 116 which is able to wirelessly communicate with one or more of the AP MLDs 112, 114. The multi-link communications system 100 can be used in various applications, such as industrial applications, medical applications, computer applications, and/or consumer or enterprise applications. In some embodiments, the multi-link communications system 100 may be a wireless communications system, such as a wireless communications system compatible with an Institute of Electrical and Electronics Engineers (IEEE) 802.11 protocol. For example, the multi-link communications system 100 may be a wireless communications system compatible with an IEEE 802.11bn protocol and various other iterations of the 802.11 specification are referred to herein including but not limited to IEEE 802.11ac, IEEE 802.11be, and IEEE 802.11ax. IEEE 802.11ac is referred to as very high throughput (VHT). IEEE 802.11ax is referred to as high efficiency (HE). IEEE 802.11be is referred to as extreme high throughput (EHT). IEEE 802.11bn is referred to as ultra-high reliability (UHR). A configuration of the multi-link communications system 100 is shown for different time instances t₀, t₁, t₂ while the non-AP MLD 116 performs a roaming between the AP MLDs 112, 114 of the roaming domain 110.

Although the depicted multi-link communications system 100 is shown in FIG. 1 with certain components and described with certain functionality herein, other embodiments of the multi-link communications system 100 may include fewer or more components to implement the same, less, or more functionality. In some embodiments, the multi-link communications system 100 includes multiple associated non-AP MLDs. In some embodiments, an AP MLD may have a single affiliated AP. In some embodiments, a non-AP MLD may have a single affiliated STA. In some embodiments, the roaming domain 102 may have more than two affiliated AP MLD or less than two affiliated AP MLD. In some embodiments, the non-AP MLD 116 may have a plurality of links to one or more respective AP MLDs. Although the multi-link communications system 100 is shown in FIG. 1 as being connected in a certain topology, the network topology of the multi-link communications system is not limited to the illustrated topology.

The roaming domain 110 has AP MLD 112 and AP MLD 114 which are collectively referred to herein as a distributed AP MLD group. In one or more embodiments, the distributed AP MLD group may be an extended service set (ESS) or part of an ESS. In some embodiment, some upper layer Media Access Control (MAC) functionalities (association, authentication, pairwise transient key (PTK) key negotiation, stream classification service (SCS) agreement, emergency preparedness communication service (EPCS) authorization, block acknowledgement (BA) agreement negotiation, MLD level power save of maximal idle period, etc.) are implemented in the roaming domain 110. In some embodiments, some upper layer Media Access Control (MAC) functionalities (e.g., reordering of frames, STR/NSTR/MLSR/EMLSR, MLD level power save except maximal idle period, etc.) are implemented in a common MAC of an AP MLD 112, 114, and the APs of the AP MLD implement lower layer MAC functionalities (e.g., backoff, frame transmission, frame reception, etc.). The roaming domain 110 may be implemented in hardware (e.g., circuits), software, firmware, or a combination thereof and fully or partially implemented as an integrated circuit (IC) device.

In one or more embodiments, AP MLD 112 may have APs 126, 128 and AP MLD 114 may have APs 130, 132. In some embodiments, the APs may be wireless APs compatible with at least one WLAN communications protocol (e.g., at least one IEEE 802.11 protocol) and be implemented in hardware (e.g., circuits), software, firmware, or a combination thereof. The APs may be fully or partially implemented as an IC device. In some embodiments, each AP includes at least one antenna, at least one transceiver operably connected to the at least one antenna, and at least one controller connected to the corresponding transceiver. In some embodiments, an AP affiliated with an AP MLD includes multiple RF chains and the at least one transceiver in a PHY circuit of the AP. The at least one controller may be configured to control the at least one transceiver to transmit and receive frames. In some embodiments, the at least one controller may be implemented within a processor, such as a microcontroller, a host processor, a host, a DSP, or a CPUs. In one or more embodiments, each of the APs may define different basic service set (BSS) operating channel operating in different frequency bands. The APs may operate in one of a 5 GHz or 6 GHz band. In one or more embodiments, the AP MLD 112 includes a 5 GHz AP 126 and 6 GHz AP 128. The AP MLD 114 includes a 5 GHz AP 130 and 6 GHz AP 132.

In some embodiments, the AP MLDs are coupled to a distribution system 108 which could be an Ethernet switch or access server which facilitates communication with a local area network (e.g., a LAN) or a backbone network (e.g., the Internet) through a wired connection and which wirelessly connects via an AP MLD to the non-AP MLD 120 using a wireless protocol such as IEEE 802.11 protocol. The distribution system 108 may transmit or receive frames between the LAN or backbone network and one or both of the AP MLD 112, 114.

The non-AP MLD 116 includes two non-AP STAs 134, 136 which are implemented in hardware (e.g., circuits), software, firmware, or a combination thereof. The STAs 134, 136 may be fully or partially implemented as an IC device. In some embodiments, the STAs 134, 136 are part of the non-AP MLD 116, such that the non-AP MLD 116 may be a communications device that wirelessly connects to one or more AP MLD 112, 114. For example, the non-AP MLD 116 may be implemented in a laptop, a desktop personal computer (PC), a mobile phone, or other communications device that supports at least one WLAN communications protocol. In some embodiments, the non-AP MLD 120 implements MAC functionality which is divided between an MLD level common MAC functionality and the non-AP STAs 122 and 124 implement lower layer MAC data functionality. In some embodiments, each STA includes at least one antenna, at least one transceiver operably connected to the at least one antenna, and at least one controller connected to the corresponding transceiver. In some embodiments, an STA affiliated with a non-AP MLD includes multiple RF chains and the at least one transceiver in a PHY circuit of the STA. The at least one controller may be configured to control the at least one transceiver to transmit and receive frames. In some embodiments, the at least one controller may be implemented within a processor, such as a microcontroller, a host processor, a host, a DSP, or a CPU. The STAs may operate in one of a 5 GHz or 6 GHz band.

The roaming domain 110 with AP MLDs 112, 114 positioned at different physical locations of the multi-link communications system 100 facilitates smooth roaming by a non-AP MLD 116 within an area covered by the roaming domain 110. Because the area covered is large, chance of the non-AP MLD 116 transitioning from an AP MLD of one roaming domain to an AP MLD of another roaming domain is reduced. The non-AP MLD 116 sets up the association with the roaming domain 110 through the links of one AP MLD affiliated with the roaming domain 110 or during a roaming operation temporarily sets up links with multiple AP MLDs affiliated with the roaming domain 110 referred to as a multiple AP MLD mode roaming (also called link level roaming). In some embodiments, during a roaming operation a non-AP MLD temporarily sets up links with single AP MLD affiliated with the roaming domain 110 referred to as a single AP MLD mode roaming (also called MLD level roaming). The links may be wireless connections between components of the multi-link communications system 100.

Embodiments disclosed herein are directed to a non-access point (non-AP) multi-link device (MLD) 116 roaming among AP MLDs 112, 114 affiliated with a roaming domain 110 in the multiple AP MLD mode. The non-AP MLD 116 may initially set up an association with roaming domain 102 through links 118, 120 of an AP MLD 112 affiliated with a roaming domain 102 referred to as the serving AP MLD 112 at time to. The links facilitate uplink and downlink communication between the AP MLD 112 and the non-AP MLD 116 and each link defines a connection between an AP MLD and non-AP MLD. The non-AP MLD 116 performs a link-level roaming process by maintaining one or more of the setup link(s) with the serving AP MLD 112 and setting up link(s) to the target AP MLD 114 (with a frame exchange context also being established at target AP MLD 114) at time t₁. For example, link 120 is terminated and link 122 is set up while keeping link 118 to the AP MLD 112. Then as part of the link-level roaming at a last stage of roaming procedure after a frame exchange context is established and a DS mapping change of the non-AP MLD 116 is updated, the non-AP MLD may execute the data frame exchanges with two AP MLDs during a temporary roaming stage. Then, the non-AP MLD 120 sets up all link(s) from the non-AP MLD 116 to the target AP MLD 114 at time t₃. For example, the link 118 is terminated and link 124 is set up. The non-AP MLD's set-up links 118, 122 with two AP MLDs 112, 114 (AP MLD1 and AP MLD2) affiliated with the roaming domain 110 is allowed only during a temporary roaming stage of the roaming by non-AP MLD 102 from AP MLD1 112 (a serving AP MLD) to AP MLD2 114 (a target AP MLD). When a non-AP MLD 116 roams among the AP MLDs 112, 114 affiliated with the roaming domain 110, the transition between AP MLDs 112, 114 occurs without a need for reassociation, referred to as smooth roaming, since the non-AP MLD 116 has already made an association with the roaming domain 110 through an AP MLD (such as the serving AP MLD) affiliated with the roaming domain 110. Before the non-AP MLD's links with the AP MLD112 are terminated, temporarily the non-AP MLD 116 can receive the DL frames from both AP MLD 112 and AP MLD 114 while the non-AP MLD 116 can transmit the UL frames to the AP MLD 114. In one or more embodiments, whether the non-AP MLD can simultaneously do the frame exchanges with the two AP MLDs may be announced by the non-AP MLD. In some embodiments, a type of the two links of the non-AP MLD 116 temporarily associated with two AP MLDs 112, 114 other than STR link pair may be announced. The two links may be a non-simultaneous transmit receive (NSTR) pair, a multi-link single radio (MLSR) pair, or enhanced MLSR (eMLSR) pair when the link pair is respective links between the non-AP MLD 116 and two AP MLDs 112, 114. The two links that belong to respective AP MLDs 112, 114 as a link pair need to each transmit a PPDU which stop at a same time which could not be possible when the non-AP MLD 116 has links to two AP MLDs 112, 114. To facilitate this operation, one link is only used for the frame exchange and the STA of non-AP MLD in the other link is in power save mode and doze state so that stopping a PPDU transmitted on the two links at a same time is not needed. When the two links established with the serving AP MLD 11 and target AP MLD 114 are a non-simultaneous transmit receive (NSTR) pair, a multi-link single radio (MLSR) pair, or enhanced MLSR (eMLSR) pair, only one PPDU is transmitted in one of the two links at a time based on a power save where a STA of the non-AP MLD 116 in only one of the two links is in a wake state, the negotiated time wake time (TWT) agreements for the two links of the NSTR pair, MLSR pair, or eMLSR pair with non-overlapped TWT SPs of the TWT agreements in time domain in two links, a (multi user (MU)) request to send/clear to send (RTS/CTS) frame exchange before the data frames exchanges on a link of the NSTR/MLSR/EMLSR pair, or the non-AP MLD can only do frame exchange with one AP MLD during the temporary roaming (i.e., the frame exchange between the non-AP MLD and target AP MLD is performed after the links with the serving AP MLD are terminated, the frame exchange context at target AP MLD is established, and a distributed system mapping change is finished). The non-AP MLD and one or more of the AP MLD are arranged to communicate in an uplink and/or downlink direction and with only one physical layer protocol data unit (PPDU) transmitted in one of the two links at a time. The roaming domain 110 determines that the non-AP MLD 116 is able to transmit frames in an uplink (UL) direction to both AP MLDs after a distributed system mapping change is completed, and during the temporary stage, the AP MLD 112, 114, the non-AP MLD 116 negotiate that the non-AP MLD 116 is able to transmit frames in an uplink (UL) direction to both AP MLDs after a distributed system mapping change is completed, and during the temporary stage, or UL frames are able to be transmitted from the non-AP MLD to only the target AP MLD 114 after a distributed system mapping change is completed and during the temporary roaming. In some embodiments, the transmission of the frames in an uplink (UL) direction to both AP MLDs is always disallowed during the temporary roaming. The roaming domain 110 and non-AP MLD 116 negotiate that both AP MLDs transmit frames downlink (DL) frames of a traffic identifier (TID) to the non-AP MLD 116 after a distributed system mapping change is completed, and during the temporary stage or DL frames are transmitted by one AP MLD such as the target AP MLD 114 after a distributed system mapping change is completed and during the temporary roaming.

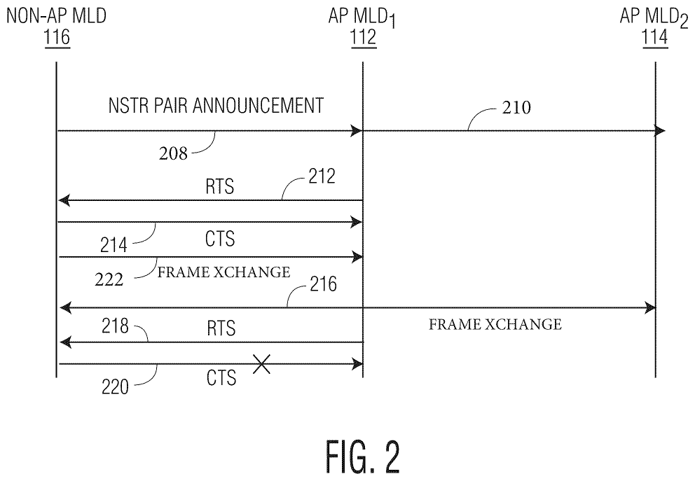

FIG. 2 is an example of communications associated with performing link-level roaming in the multi-link communications system 100 based a non-AP MLD 116 being temporarily associated with two AP MLDs 112, 114 by a non-simultaneous transmit receive (NSTR) link pair in accordance with one or more embodiments. The non-AP MLD 116 may be temporarily roaming and have link 118 to AP MLD 112 which is a serving AP MLD and link 122 to AP MLD 114 which is a target AP MLD. In 802.11be, when two APs transmit PPDUs to a non-AP MLD 116 simultaneously through two links of a NSTR link pair, the two PPDUs need to stop at the same time. The NSTR is a link pair where a transmitter and receiver associated with a respective link are not able to transmit and receive at a same time. The non-AP MLD 112 may have setup links 118, 122 to AP MLD 112, 114 where the links 118, 122 form a NSTR link pair (i.e., being not able to form a STR link pair). The non-AP MLD 116 may send a notification 208, 210 that the links 118, 122 form an NSTR pair. The notification 208, 210 may be in the form of an IEEE 802.11 action frame in one or more embodiments. A notification 210 to the AP MLD 114 may also be a proprietary message between two AP MLDs. When an AP MLD intends to use one link of a NSTR link pair 118, 122 to do frame exchanges with the non-AP MLD 116 that announces the NSTR link pair 118, 122 with two AP MLDs 112, 114, the AP MLD 112 which is a serving AP MLD needs to start its transmit opportunity (TXOP) by sending a request to send (RTS) 212 at the beginning of a TXOP which could be a multi-user (MU) RTS over the link 118 to the non-AP MLD 116 followed by the non-AP MLD 116 sending a clear to send (CTS) 214 over the link 118 before transmitting a PPDU to the non-AP MLD 116. If the RTS/CTS handshake is successful, the non-AP MLD 116 and AP MLD 112 executes the data frame exchanges 222 until the end of the TXOP. If the non-AP MLD 116 does frame exchanges 216 with one AP MLD 114 through link 118 of a NSTR link pair and receives a (MU-)RTS 218 in link 122 of the NSTR link pair from AP MLD 112, the non-AP MLD 116 will not respond with the CTS shown by CTS 220 with a cross so that the requirement that PPDUs transmitted over the two links need to be stopped at the same time is maintained.

In one or more embodiments, a control frame exchange may be defined between an AP MLD and the non-AP MLD 116. The control frame may include a request frame transmitted by an AP MLD to request to transmit in a transmit opportunity (TXOP) to the non-AP MLD and a responding frame transmitted by the non-AP MLD 116 notifies the AP MLD whether the non-AP MLD 116 is able start the TXOP. In some embodiments, the responding frame may indicate a time when the TXOP is to start if the AP MLD is not able to start the TXOP at the requested time so that PPDUs are not transmitted on both links 118, 122 at a same time.

In one or more embodiments, the two links 118, 120 may be temporally associated with the AP MLDs 112, 114 during the roaming stage when a frame exchange context is provided by the AP MLD 112 to the AP MLD 114 and a distributed system (DS) mapping change is updated. The frame exchange between the non-AP MLD 116 and target AP MLD 114 is performed after frame exchange context is established at the target AP MLD 114 and a distributed system mapping change is finished. The frame exchange context may define a context associated with uplink (UL) frame transmissions from the non-AP MLD 116 to an AP MLD and downlink (DL) frame transmissions from the AP MLD to the non-AP MLD 116. The DS mapping is a process by which the distribution system 108 transmits downlink (DL) MAC service data unit (MSDU) addressed to the non-AP MLD 116 to the correct AP MLD and receives uplink (UL) MSDUs of the non-AP MLD 116 from the correct AP MLD.

In one or more embodiments for DL transmission context of unicast data frames of each traffic identifier (TID) which identifies a type of service required for a frame (e.g., priority), one or more of an allocated maximal sequence number (SN) (or unallocated smallest SN that is equal to allocated maximal sequence number plus 1), block acknowledgement (BA) parameters (if the BA agreement exists for the TID, a BA buffer size, BA timers are used to decide whether BA needs to be removed to establish an inactive BA agreement), and a WinStartO (if the BA agreement exists for the TID and both two AP MLDs transmit DL frames of the TID to the non-AP MLD) may be defined and provided from the serving AP MLD to the target AP MLD (new serving AP MLD). The allocated maximal sequence number may be used to figure out the next sequence number for the new MPDU of the TID. The sequence number is included in a MAC header of the frame and used by a receiver to detect duplicate frames, missing frames, and to deliver the frames in ascending order of sequence numbers to a higher processing layer. The WinStartO may be a window starting sequence number of a transmit buffer control used by the AP MLD to transmit DL frames in a transmit buffer with a buffer size of WinSizeO corresponding to a number of frames to transmit. The WinSizeO is decided by the negotiated buffer size of the BA agreement. When two AP MLDs transmit the DL frames of a TID to the non-AP MLD, the target AP MLD cannot transmit the frame with SN>WinStartO+WinSizeO. Block acknowledgement (BA) parameters of each BA agreement (DL and UL BA agreements are separate agreements) for a TID between the non-AP MLD and the roaming domain may include a negotiated buffer size to set up a block acknowledgement session, whether A-MSDU is allowed, BA active timer etc. In one or more embodiments, an minimal unallocated packet number (PN) (or the maximal allocated PN that is equal to minimal unallocated PN minus 1) in a PN space and Pairwise Transient Key (PTK) are defined as a security context for the DL unicast data frames and management frames. The PTK is a concatenation of session keys that includes temporal key used to protect unicast traffic between a client and an access point (AP) and the PN space is defined for replay check at MLD level.

In one or more embodiments for UL transmission context of data frames of each TID, one or more of a sequence number for duplicate detection may be defined for the TID transmitted when there is no BA agreement and a maximal sequence number of the MPDUs to be transmitted to the up layer may be defined for the TID with BA agreement. A replay counter for each TID and PTK are defined as the security context for the UL unicast data frames and a replay counter for management frames is defined as the security context for the UL unicast management frames (or a replay counter for each UL management frame access category). In one or more embodiments, the replay check is a counter which keeps track of a next frame such as a management frame to be received and therefore when a frame is being replayed by an attacker, the replay counter will have a value no more than the PN of the received frame which means the received frame should be dropped.

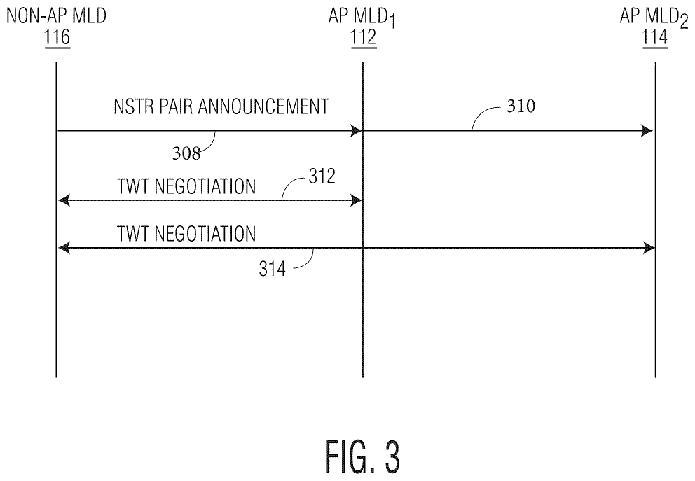

FIG. 3 is another example of communications associated with performing link-level roaming in the multi-link communications system 100 based on the non-AP MLD being temporarily associated with two AP MLDs by a non-simultaneous transmit receive (NSTR) link pair of in accordance with one or more embodiments. The non-AP MLD 116 may be temporarily roaming and have link 118 to AP MLD 112 which is a serving AP MLD and link 122 to AP MLD 114 which is a target AP MLD. The non-AP MLD 116 notifies the two serving AP MLDs 112, 114 that its two links 118, 122 associated with the AP MLDs 112, 114 are an NSTR link pair (i.e., are not a STR link pair). The notification 308, 310 may be in the form of an IEEE 802.11 action frame in one or more embodiments. A notification 310 may also be a proprietary message between two AP MLDs. In one or more embodiments, the STAs of non-AP MLD 116 in the NSTR link pair may establish individual TWT agreements with the serving AP MLD 112 and the target AP MLD 114. The individual TWT agreement with the serving AP MLD 112 and individual TWT agreement with the target AP MLD 114 have the non-overlapped target wake time (TWT) service periods (SPs) in a time domain. With TWT operation, the non-AP MLD 116 do the frame exchange at a pre-scheduled time (TWT service periods (SPs) of the TWT agreement). The non-AP MLD 116 may negotiate by a frame exchange 312, 314 individual TWT agreements in two links 118, 120 of the NSTR link pair with the two AP MLDs 112, 114 where a transmission in a respective TXOP of the STAs 134, 136 coupled to the two links 118, 1120 do not overlap with each other in the non-overlapped TWT SPs of the individual TWT SPs in two NSTR links in a time domain. During a TWT SP of an STA, the STA may be in a wake state to transmit to an AP MLD over a link 118, 122 and otherwise be in the doze state of power save mode outside the TWT power save (PS) of the STA so that the non-AP MLD uses only one link to do the frame exchanges with a AP MLD while another AP MLD will not do the frame exchange with the non-AP MLD.

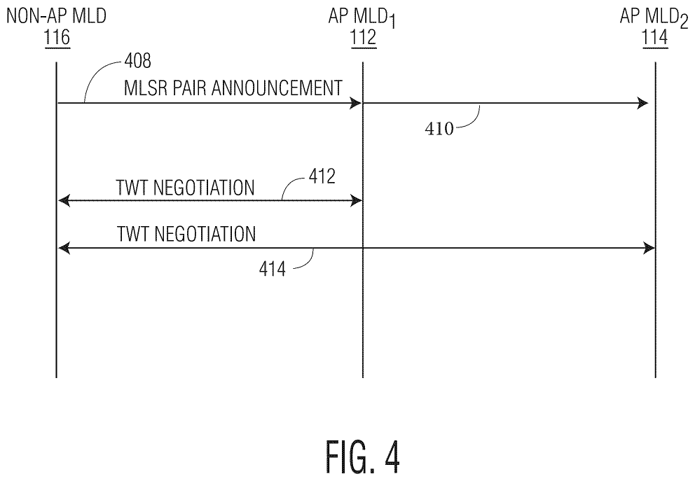

FIG. 4 is an example of communications associated with performing link-level roaming in a multi-link communications system 100 based a non-AP MLD 116 being associated with two AP MLDs 112, 114 via links 118, 122 which operate as a MLSR/eMLSR pair in accordance with one or more embodiments. The non-AP MLD 116 may be temporarily roaming and have link 118 to AP MLD 112 which is a serving AP MLD and link 122 to AP MLD 114 which is a target AP MLD. In 802.11be, the two APs of the AP MLDs are not allowed to transmit PPDUs to a non-AP MLD 116 overlapped in time domain through two links of the MLSR/eMLSR link pair. In one or more embodiments, a non-AP MLD 116 may notify the AP MLDs 112, 114 that it is an non-AP MLD 116 having a MLSR/eMLSR link pair (i.e., not STR link pair). A notification 408, 410 may be in the form of an IEEE 802.11 action frame in one or more embodiments. A notification 410 may also be a proprietary message between two AP MLDs. In one or more embodiments, the STAs of non-AP MLD 116 in the MLSR/eMLSR link pair may establish the individual TWT agreements with the serving AP MLD 112 and the target AP MLD 114. The individual TWT agreement with the serving AP MLD 112 and individual TWT agreement with the target AP MLD 114 have the non-overlapped target wake time (TWT) service periods (SPs) in a time domain. With TWT operation, the non-AP MLD 116 do the frame exchange at a pre-scheduled time (TWT service periods (SPs) of the TWT schedule). The non-AP MLD 116 may negotiate by a frame exchange 412, 414 of individual TWT agreements in two links 118, 120 of the MLSR/eMLSR pair with the two AP MLDs 112, 114 where a transmission in a respective TXOP of the STAs 134, 136 coupled to the two links 118, 120 do not overlap with each other in the non-overlapped TWT SPs of the individual TWT SPs in two MLSR/eMLSR pairs in a time domain. During a TWT SP of an STA, the STA may be in a wake state to transmit to an AP MLD over a link 118, 122 and otherwise be in the doze state of power save mode outside the TWT power save (PS) of the STA so that the non-AP MLD 116 uses only one link to do the frame exchanges with a AP MLD while another AP MLD will not do the frame exchange with the non-AP MLD 116.

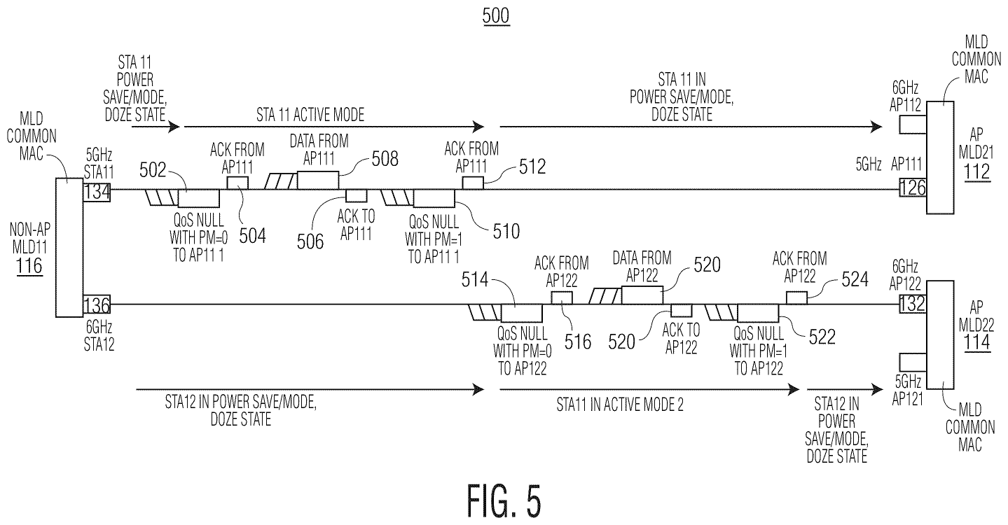

FIG. 5 illustrates in more detail example frame exchange 500 between the non-AP MLD 116 and two AP MLDs 112, 116 with NSTR, MLSR, eMLSR links during the link-level roaming in accordance with one or more embodiments. One link of the non-AP MLD 116 may be set up with AP MLD 112 and another link of the non-AP MLD 116 may be set up with AP MLD 114. The frame exchange between the non-AP MLD 116 and target AP MLD 114 is performed after frame exchange context is established and a distributed system mapping change is completed. The STAs 134 (STA11), 136 (STA12) of the non-AP MLD 116 may be both in a power save mode and doze state after the non-AP MLD 116 announces a link pair type before any frame exchange and after a frame exchange context is established and DS mapping change. The STA 134 may send a quality of service (QoS) null frame 502 with a power management=0 to indicate to the AP 126 (AP111) that is it transitioned to an active mode. The STAs 134 may receive an acknowledgement 504 to the null frame 502 and data 506 from the AP 126 of AP MLD 112. The STA 134 may send an acknowledgment 508 to the data 506 and then a quality of service (QoS) null frame 510 with a power management=1 to indicate to the AP 126 that is it transitioned to a power save mode and doze state which is acknowledged by acknowledgement 512 by the AP 126. Then, the STA 136 (STA12) may send an quality of service (QoS) null frame 514 with a power management=0 to indicate to the AP 132 (AP122) that is it transitioned to an active mode while the STA 134 is in the power save mode and doze state. The STA 136 may receive an acknowledgement 516 to the null frame 514 from the AP 132 of another AP MLD and data 518 from the AP 132 followed by the STA 136 sending an acknowledgement 520. The STAs 136 may send an quality of service (QoS) null frame 522 with a power management=1 to indicate to the AP 132 that is it transitioned to a power save mode and doze state followed by an acknowledgement 524. The non-AP MLD 116 uses only one link to do the frame exchanges with a AP MLD while another AP MLD will not do the frame exchange with the non-AP MLD so that the requirement that PPDUs transmitted over the two links need to be stopped at the same time is maintained.

In one or more embodiments, a non-AP MLD 116 may not perform link-level roaming if two links of the non-AP MLD 116 that associated with two AP MLDs 112, 114 belong to a NSTR, MLSR, eMLSR link pair, or if the non-AP MLD 116 does not want to do the frame exchanges with the two AP MLDs temporarily. The non-AP MLD 116 is only able to transmit or receive with the roaming domain 110 when associated with a single AP MLD and links to the single AP MLD. Before the DS mapping change is finished, the non-AP MLD 116 does not do the frame exchanges with the target AP MLD 114. After the links with the target AP MLD 114 are set up (i.e., the frame exchange context with the target AP MLD 114 is established), the links with the serving AP MLD 112 are terminated, and the DS mapping change is finished, the non-AP MLD 116 does not do the frame exchanges with the serving AP MLD 112 and only does the frame exchanges with the target AP MLD 114.

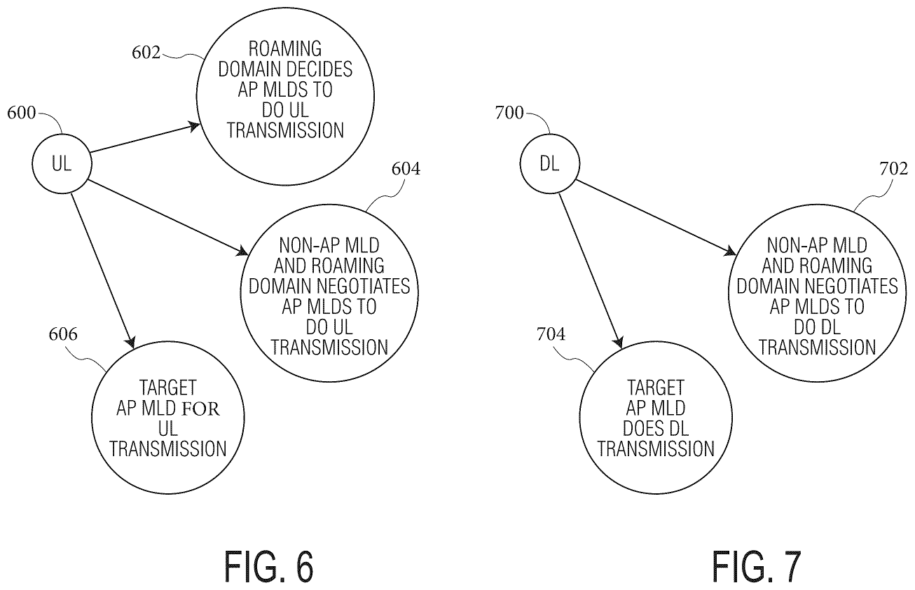

FIG. 6 describes example uplink (UL) communication 600 options for link-level roaming in the multi-link communications system 100 by a non-AP MLD 116 associated with AP MLDs 112, 114 in accordance with one or more embodiments. The non-AP MLD and one or more of the AP MLD are arranged to communicate in an uplink direction and with only one PPDU transmitted in one of the two links at a time. The non-AP MLD 116 may be temporarily roaming and have link 118 to AP MLD 112 which is a serving AP MLD and link 122 to AP MLD 114 which is a target AP MLD. In one option 602, the roaming domain 110 may specify (e.g., announce in an action frame) that the non-AP MLD 116 is able to transmit frames in an uplink (UL) direction to two AP MLDs 112, 114 after the DS mapping change is finished. The AP MLD to which the non-AP MLD 102 may transmit UL frames is based on traffic identifiers (TIDs) of the frames and in some embodiments a traffic identifier (TID)-to-link mapping. The TID may indicate a type of packet to be transmitted and corresponding type of service needed to achieve a certain quality of service (QoS). The TID-to-link mapping may indicate which link and associated AP MLD the packet with the TID should be mapped for the transmission to meet the QoS. In another option 604, the non-AP MLD 116 and the roaming domain 110 may negotiate that both AP MLDs 112, 114 can do the frame exchanges for the UL frames with TIDs after the DS mapping change is finished and during a temporary stage. The negotiation may include the non-AP MLD 116 sending a request to send uplink frames with a TID to both AP MLDs and one or both AP MLDs may provide a response to either accept or deny the request. When the UL frame exchanges are performed with both AP MLDs 114, 116, one AP MLD which is the serving AP MLD associated with the roaming needs to provide access to a reorder buffer to the other AP MLD which is the target AP MLD. The reorder buffer is a functionality that guarantees in-order delivery of frames to an upper layer and is defined by the WinStartB, WinSizeB, and the buffered frames. The reordering buffer shall be responsible for reordering frames in order of received sequence number. It shall also be responsible for identifying and discarding duplicate frames (i.e., frames that have the same sequence number as a currently buffered frame) that are part of a block acknowledgement. The WinStartB identifies the start SN of the frame that is received correctly and WinSizeB defines the number of frames waiting for the reordering which is used to track the SN of frames which are received by the AP MLD 114. When ordered frames have been received of WinSizeB starting from WinStartB, the AP MLD 114 provides the frames to upper layer processing until all the frames in the reorder buffer are sent to the up layer or until one SN whose frame is not received correctly is found. In yet another option 606, the frames of UL TIDs will be transmitted by the non-AP MLD 116 to only the target AP MLD. Before the frame exchange context is established and after the DS mapping change, the frames are not transmitted to AP MLD 114 (target AP MLD). After the frame exchange context is established, after the DS mapping change, the frames are transmitted to AP MLD 114 (target AP MLD) but are not transmitted to AP MLD 112 (serving AP MLD).

FIG. 7 describes example downlink (DL) communication 700 options for link-level roaming in the multi-link communications system 100 by the non-AP MLD 116 associated with two AP MLDs 112, 114 in accordance with one or more embodiments. The non-AP MLD 116 may be temporarily roaming and have link 118 to AP MLD 112 which is a serving AP MLD and link 122 to AP MLD 114 which is a target AP MLD. The non-AP MLD and one or more of the AP MLD are arranged to communicate in a downlink direction and with only one PPDU transmitted in one of the two links at a time. In one option 702, a negotiation is performed between the non-AP MLD 116 and the AP MLDs 112, 114 that both AP MLD s 106, 108 may transmit the frames in the DL direction to the non-AP MPD 116 after link 118 is set up between the non-AP MLD 116 and AP MLD 112, link 122 is set up between the non-AP MLD 116 and AP MLD 114, the frame exchange context is established in target AP MLD 114, and the DS mapping change is performed. Further, the AP MLDs 112, 114 may transmit DL frames of TIDs to the non-AP MLD 116 via links which in some embodiments are indicated by a TID-to-link mapping of the two AP MLDs 112, 114. When the DL frame exchanges can be done with both AP MLDs 112, 114, a serving AP MLD 112 needs to forward its transmit buffer information (WinStartO, WinSizeO) and may forward the buffered frames in a transmit buffer to the AP MLD 114. In another option 704, the DL frames of TIDs will be transmitted by one AP MLD. In one or more embodiments, the DL frames of TIDs will not be transmitted by AP MLD 114 to the non-AP MLD 116 before DS mapping change for the non-AP MLD 116 is finished. After the frame exchange context is established in the target AP MLD and the DS mapping change, the frames of certain TID are transmitted by AP MLD 114 and not transmitted by AP MLD 112. In some embodiments, the roaming domain and non-AP MLD 116 negotiate that both AP MLDs transmit frames with a downlink (DL) traffic identifier (TIDs) to the non-AP MLD 116 not associated with a TID to link mapping after the DS mapping change is finished and during the temporary stage, with the non-AP MLD 116 having links to AP MLD 112 and AP MLD 114.

The non-AP MLD 116 associated with the roaming domain 108 may roam from AP MLD 112 (serving AP MLD) via links 118, 120 to being associated with AP MLD 112, 114 via links 118, 120 through the link-level roaming.

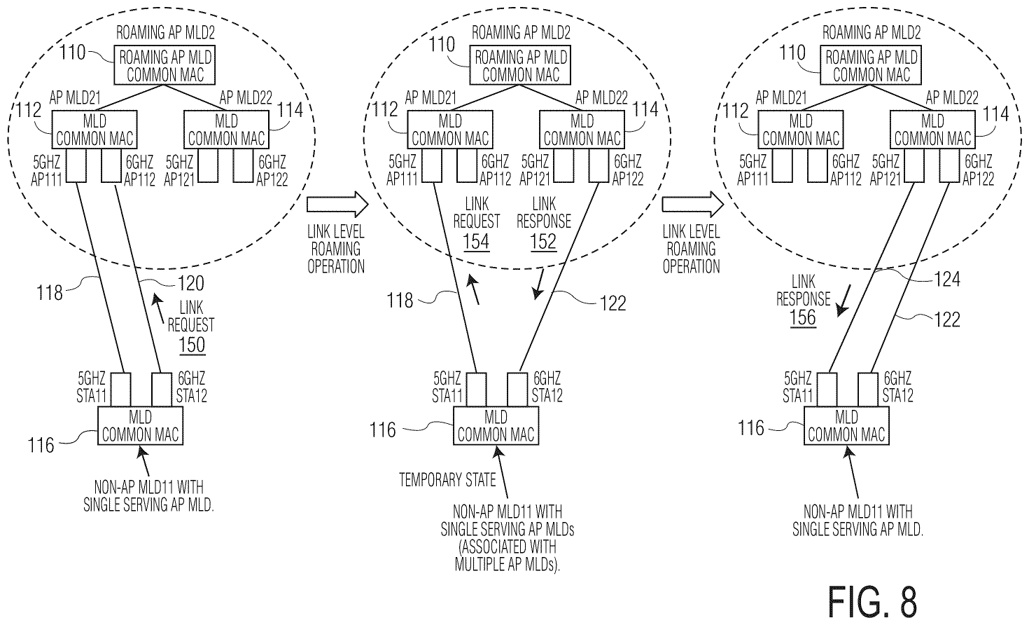

FIG. 8 is an example of signaling by the non-AP MLD to perform a roaming operation in the multi-link communications system 100 in accordance with one or more embodiments. A non-AP MLD 116 associated with the roaming domain 110 initiates the roaming from the AP MLD 112 affiliated with the roaming domain 110 to the AP MLD 114 affiliated with the roaming domain 110. The non-AP MLD 116 may have links 118, 120 to the AP MLD 112 before the roaming starts. The non-AP MLD 116 may send a Link Reconfiguration Request (shown as Link Request) 150 defined by IEEE 802.11 or new action frame to set up link 122 to AP MLD 114. The Link Reconfiguration Request 150 may be sent over the link 120. A response frame 152 (shown as Link Response) defined by IEEE 802.11 or new action frame is received over the link 122 and may indicate that the non-AP MLD 116 is associated with the AP MLD 112, 114 via links 118, 122 and a UL frame reception context is ready at AP MLD 114. Link 120 may then be terminated in an example. Then the DS mapping change is initiated. The DS mapping change for the link to the target AP MLD may be configured through an action request/response frame handshake by the non-AP MLD 116 and roaming AP MLD 102 in an example. After the DS mapping change is completed, the UL frame exchanges can be done with AP MLD 114, and the UL frame exchanges may not be done with AP MLD 112. After the DS mapping change is finished, DL frames may be temporarily sent by AP MLD 112 and AP MLD 114 based on a TID in the frame in one or more embodiments. Then, the non-AP MLD 116 associated with AP MLD 112 and AP MLD 114 affiliated with the roaming AP MLD 110 initiates setting up all its links to the AP MLD 114 by sending a Link Reconfiguration Request 154 over the link 118. After the response 156 is received over the link 124, link 118 is terminated. All links from the non-AP MLD 116 to the AP MLD 114 is set up and the DL data frame transmission by AP MLD 112 is not allowed after the DS mapping change is finished.

In some examples, a Link Recommendation Query defined by IEEE 802.11,background traffic management (BTM) Request/Response defined by IEEE 802.11, or the new defined action frames can be used by the roaming domain 110 to recommend an AP MLD for the non-AP MLD 116 to associate with. In the query or request, the non-AP MLD 116 provides to the roaming domain 110 information about the STAs of the non-AP MLD which the roaming domain 110 uses to recommend a target AP MLD to which the non-AP MLD is to roam to establish the link 122 to AP MLD 114 and the links 122, 124 to AP MLD 114.

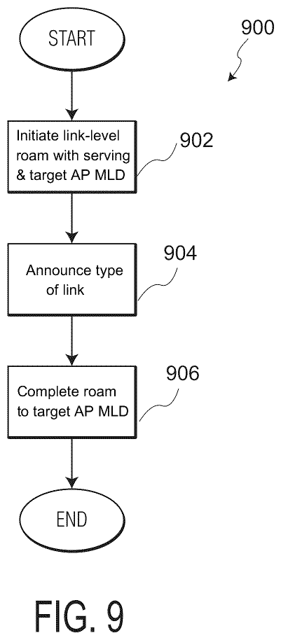

FIG. 9 is an example flow chart 900 of functions associated with link-level roaming in the multi-link communication system 100 in accordance with one or more embodiments. Functions may be performed by the wireless devices in the multi-link wireless communication network 100 after two links are initially set up to the serving AP MLD.

At 902, the non-AP MLD affiliated with a roaming domain initiates a link-level roaming by setting up a link to the target AP MLD while having one or more links set up to the serving AP MLD. The non-AP MLD may initiate the roaming and respective links are set up from the non-AP MLD to the serving AP MLD and target AP MLD.

At 904, the non-AP MLD announces a type of the links from the non-AP MLD to the AP MLDs. The links may be an NSTR/MLSR/eMLSR pair in which case a (MU) RTS/CTS exchange is performed by an AP MLD to transmit a frame over a link to the non-AP MLD and the non-AP MLD may not respond to an RTS on a link if another link is transmitting or receiving a PPDU so that transmission of two PPDUs do not need to stop at the same time on the links. The links may be an NSTR/MLSR/eMLSR pair in which case individual TWT agreements are negotiated for the AP MLDs on the two links to avoid two transmitted PPDUs having to stop at the same time on the links. The non-AP MLD and the roaming domain may negotiate that both AP MLDs do frame exchange with the non-AP MLD for the UL frames based on a TID of the frame after a DS mapping change is finished or the UL frames are transmitted to only the target AP MLD after a DS mapping change is finished. The roaming domain may further determine that both AP MLD is able to transmit DL frames to the non-AP MLD based on a TID of the frame after a DS mapping change is finished, the non-AP MLD and the roaming domain negotiate that both AP MLDs do frame exchange with the non-AP MLD for the DL frames based on a TID after a DS mapping change is finished or the DL frames are transmitted by only the target AP MLD after a DS mapping change is finished.

At 906, the non-AP MLD may complete the roaming by terminating all links from the non-AP MLD to the serving AP MLD and setting up additional links if required to the target AP MLD. The non-AP MLD has links set up only with the target AP MLD to complete the link level roaming. After the links are set up, DL frame transmission to the serving AP MLD is not allowed.

Even though the non-AP MLD 116 is described as exchanging frames with two AP MLD over respective links, such embodiments are not so limited. The non-AP MLD 116 may exchange frames over more than two links and to two or more AP MLD in accordance with the described principles.

In one or more embodiments, a method for a non-access point (non-AP) multi-link device (MLD) to roam among a serving AP MLD and a target AP MLD of a roaming domain, where links are initially set up from the non-AP to the serving AP MLD is disclosed. The method includes: initiating, by the non-AP MLD affiliated with the roaming domain, a link-level roaming by setting up a link to the target AP MLD, wherein respective links are set up from the non-AP MLD to the serving AP MLD and target AP MLD; announcing, by the non-AP MLD, a type of the links from the non-AP MLD to the serving AP MLD and target AP MLD; and terminating, by the non-AP MLD, all one or more links between the non-AP MLD and the serving AP MLD, wherein the non-AP MLD has links set up only with the target AP MLD to complete the link level roaming. In one or more embodiments, the non-AP MLD is not able to perform link-level roaming when the type of links is a non-simultaneous transmit receive (NSTR) pair, a multi-link single radio (MLSR) pair, or an enhanced MLSR (eMLSR) pair. In one or more embodiments, the type of links announced is a non-simultaneous transmit receive (NSTR) pair, a multi-link single radio (MLSR) pair, or an enhanced MLSR (eMLSR) pair announced in an action frame. In one or more embodiments, the method further includes the non-AP MLD receiving a request to transmit (RTS) from one AP MLD via a link and not responding to the RTS with a clear to send (CTS) if the non-AP MLD is transmitting or receiving frames with another AP MLD on another link. In one or more embodiments, the method further includes negotiating target wake times (TWTs) of the AP MLDs to cause one AP MLD to be in a power save mode while another AP MLD is in an active mode during frame exchange of the link-level roaming. In one or more embodiments, the method further includes the STAs of non-AP MLD in a NSTR/MLSR/eMLSR link pair are initially in power save mode and doze state and switches to a wake state or active mode for data frame exchanges with one of the serving AP MLD and the target AP MLD. In one or more embodiments, the method further includes the STA of non-AP MLD belonging to NSTR/MLSR/eMLSR link pair switches to power save mode and doze state after finishing the data frame exchanges with one of the serving AP MLD and the target AP MLD. In one or more embodiments, the method further includes determining, by the roaming domain, that the non-AP MLD is to transmit uplink frames during the link-level roaming to the target AP MLD after a distributed mapping change. In one or more embodiments, the method further includes transmitting, by only the target AP MLD, downlink frames to the non-AP MLD during the link-level roaming after a distributed mapping change. In one or more embodiments, the method further includes negotiating by the roaming domain and the non-AP MLD that both AP MLDs are to transmit downlink frames to the non-AP MLD during the link-level roaming after a distributed mapping change, with only one PPDU transmitted in one of the two links at a time. In one or more embodiments, the method further includes transmitting by the non-AP MLD a link configuration request to the roaming domain and receiving a response to the link configuration request to set up the link(s) to the target AP MLD; and optionally terminating one or multiple links to the serving AP MLD, and then establishing a distributed system mapping change for the link to the target AP MLD through another action request/response frame handshake. In one or more embodiments, the method further includes transmitting and receiving frames between only the non-AP MLD and target AP MLD during the link-level roaming after a frame exchange context is provided by the serving AP MLD to the target AP MLD and distributed system mapping change. In one or more embodiments, the frame exchange context includes for downlink unicast data frame transmission an allocated maximum sequence number, a WinStartO, block acknowledgement parameters, an unallocated packet number, and a Pairwise Transient Key (PTK). In one or more embodiments, the frame exchange context includes for uplink data frame transmission of frames with a traffic identifier (TID) a maximum sequence number whose related frame is sent to the up layer when block acknowledgement (BA) agreement is established for the TID and a sequence number for duplicate detection when BA agreement is not established for the TID, the PTK, and a replay counter for each TID, the replay counter for management frames.

In one or more embodiments, a non-access point (non-AP) multi-link device (MLD) is disclosed. The non-AP MLD is arranged to initiate a link-level roaming in a roaming domain by setting up a link to a target AP MLD of the roaming domain, where respective links are set up from the non-AP MLD to the serving AP MLD and target AP MLD; announce a type of the links from the non-AP MLD to the serving AP MLD and target AP MLD; and terminate all links between the non-AP MLD and the serving AP MLD, wherein the non-AP MLD has links set up only with the target AP MLD to complete the link-level roaming. In one or more embodiments, the type of links announced is a non-simultaneous transmit receive (NSTR) pair, a multilink single radio (MLSR) pair, or an enhanced MLSR (eMLSR) pair. In one or more embodiments, the non-AP MLD is further arranged to receive downlink frames from only the target AP MLD during the link-level roaming after a distributed mapping change. In one or more embodiments, the non-AP MLD is further arranged to negotiate by the roaming domain and the non-AP MLD that both AP MLDs are to transmit downlink frames to the non-AP MLD during the link-level roaming after a distributed mapping change. In one or more embodiments, a frame exchange between only the non-AP MLD and target AP MLD is performed after a distributed system mapping change and frame exchange context is established. In one or more embodiments, the frame exchange context includes for downlink unicast data frame transmission an unallocated maximum sequence number, a WinStart0, block acknowledgement parameters, an unallocated packet number, and a Pairwise Transient Key (PTK).

The foregoing disclosure provides illustration and description but is not intended to be exhaustive or to limit the aspects to the precise form disclosed. Modifications and variations may be made in light of the above disclosure or may be acquired from practice of the aspects.

It will be apparent that systems and/or methods described herein may be implemented in different forms of hardware, firmware, and/or a combination of hardware and software. The actual specialized control hardware or software code used to implement these systems and/or methods is not limiting of the aspects. Thus, the operation and behavior of the systems and/or methods were described herein without reference to specific software code--it being understood that software and hardware can be designed to implement the systems and/or methods based, at least in part, on the description herein.

As used herein, the term “non-transitory machine-readable storage medium” will be understood to exclude a transitory propagation signal but to include all forms of volatile and non-volatile memory. When software is implemented on a processor, the combination of software and processor becomes a specific dedicated machine.

Because the data processing implementing the embodiments described herein is, for the most part, composed of electronic components and circuits known to those skilled in the art, circuit details will not be explained in any greater extent than that considered necessary as illustrated above, for the understanding and appreciation of the underlying concepts of the aspects described herein and in order not to obfuscate or distract from the teachings of the aspects described herein.

Unless stated otherwise, terms such as “first” and “second” are used to arbitrarily distinguish between the elements such terms describe. Thus, these terms are not necessarily intended to indicate temporal or other prioritization of such elements.

It should be appreciated by those skilled in the art that any block diagrams herein represent conceptual views of illustrative hardware embodying the principles of the aspects.

While each of the embodiments are described above in terms of their structural arrangements, it should be appreciated that the aspects also cover the associated methods of using the embodiments described above.

Unless otherwise indicated, all numbers expressing parameter values and so forth used in the specification and claims are to be understood as being modified in all instances by the term “about.” Accordingly, unless indicated to the contrary, the numerical parameters set forth in this specification and attached claims are approximations that may vary depending upon the desired properties sought to be obtained by embodiments of the present disclosure. As used herein, “about” may be understood by persons of ordinary skill in the art and can vary to some extent depending upon the context in which it is used. If there are uses of the term which are not clear to persons of ordinary skill in the art, given the context in which it is used, “about” may mean up to plus or minus 10% of the particular term.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. A phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Furthermore, as used herein, the terms “set” and “group” are intended to include one or more items (e.g., related items, unrelated items, a combination of related and unrelated items, and/or the like), and may be used interchangeably with “one or more.” Where only one item is intended, the phrase “only one” or similar language is used. Also, as used herein, the terms “has,” “have,” “having,” and/or the like are intended to be open-ended terms. Further, the phrase “based on” is intended to mean “based, at least in part, on” unless explicitly stated otherwise.

What is claimed is:

1. A method for a non-access point (non-AP) multi-link device (MLD) to roam among a serving AP MLD and a target AP MLD of a roaming domain, wherein links are initially set up from the non-AP to the serving AP MLD, the method comprising:
initiating, by the non-AP MLD affiliated with the roaming domain, a link-level roaming by setting up a link to the target AP MLD, wherein respective links are set up from the non-AP MLD to the serving AP MLD and target AP MLD;
announcing, by the non-AP MLD, a type of the links from the non-AP MLD to the serving AP MLD and target AP MLD; and
terminating, by the non-AP MLD, all one or more links between the non-AP MLD and the serving AP MLD, wherein the non-AP MLD has links set up only with the target AP MLD to complete the link level roaming.

2. The method of claim 1, wherein the non-AP MLD is not able to perform link-level roaming when the type of links is a non-simultaneous transmit receive (NSTR) pair, a multi-link single radio (MLSR) pair, or an enhanced MLSR (eMLSR) pair.

3. The method of claim 1, wherein the type of links announced is a non-simultaneous transmit receive (NSTR) pair, a multi-link single radio (MLSR) pair, or an enhanced MLSR (eMLSR) pair announced in an action frame.

4. The method of claim 3, further comprising the non-AP MLD receiving a request to transmit (RTS) from one AP MLD via a link and not responding to the RTS with a clear to send (CTS) if the non-AP MLD is transmitting or receiving frames with another AP MLD on another link.

5. The method of claim 3, further comprising negotiating target wake times (TWTs) of the AP MLDs to cause one AP MLD to be in a power save mode while another AP MLD is in an active mode during frame exchange of the link-level roaming.

6. The method of claim 3, further comprising the STAs of non-AP MLD in a NSTR/MLSR/eMLSR link pair are initially in power save mode and doze state and switches to a wake state or active mode for data frame exchanges with one of the serving AP MLD and the target AP MLD.

7. The method of claim 6, further comprising the STA of non-AP MLD belonging to NSTR/MLSR/eMLSR link pair switches to power save mode and doze state after finishing the data frame exchanges with one of the serving AP MLD and the target AP MLD.

8. The method of claim 1, further comprising determining, by the roaming domain, that the non-AP MLD is to transmit uplink frames during the link-level roaming to the target AP MLD after a distributed mapping change.

9. The method of claim 1, further comprising transmitting, by only the target AP MLD, downlink frames to the non-AP MLD during the link-level roaming after a distributed mapping change.

10. The method of claim 1, further comprising negotiating by the roaming domain and the non-AP MLD that both AP MLDs are to transmit downlink frames to the non-AP MLD during the link-level roaming after a distributed mapping change, with only one physical layer protocol data unit (PPDU) transmitted in one of the two links at a time.

11. The method of claim 1, further comprising transmitting by the non-AP MLD a link configuration request to the roaming domain and receiving a response to the link configuration request to set up the link(s) to the target AP MLD; and optionally terminating one or multiple links to the serving AP MLD, and then establishing a distributed system mapping change for the link to the target AP MLD through another action request/response frame handshake.

12. The method of claim 1, further comprising transmitting and receiving frames between only the non-AP MLD and target AP MLD during the link-level roaming after a frame exchange context is provided by the serving AP MLD to the target AP MLD and distributed system mapping change.

13. The method of claim 12, wherein the frame exchange context includes for downlink unicast data frame transmission an allocated maximum sequence number, a WinStartO, block acknowledgement parameters, an unallocated packet number, and a Pairwise Transient Key (PTK).

14. The method of claim 12, wherein the frame exchange context includes for uplink data frame transmission of frames with a traffic identifier (TID) a maximum sequence number whose related frame is sent to the up layer when block acknowledgement (BA) agreement is established for the TID and a sequence number for duplicate detection when BA agreement is not established for the TID, the PTK, and a replay counter for each TID, the replay counter for management frames.

15. A non-access point (non-AP) multi-link device (MLD) arranged to initiate a link-level roaming in a roaming domain by setting up a link to a target AP MLD of the roaming domain, wherein respective links are set up from the non-AP MLD to the serving AP MLD and target AP MLD; announce a type of the links from the non-AP MLD to the serving AP MLD and target AP MLD; and terminate all links between the non-AP MLD and the serving AP MLD, wherein the non-AP MLD has links set up only with the target AP MLD to complete the link-level roaming.

16. The non-AP MLD of claim 15, wherein the type of links announced is a non-simultaneous transmit receive (NSTR) pair, a multilink single radio (MLSR) pair, or an enhanced MLSR (eMLSR) pair.

17. The non-AP MLD of claim 15, wherein the non-AP MLD is further arranged to receive downlink frames from only the target AP MLD during the link-level roaming after a distributed mapping change.

18. The non-AP MLD of claim 15, wherein the non-AP MLD is further arranged to negotiate by the roaming domain and the non-AP MLD that both AP MLDs are to transmit downlink frames to the non-AP MLD during the link-level roaming after a distributed mapping change, with only one physical layer protocol data unit (PPDU) transmitted in one of the two links at a time.

19. The non-AP MLD of claim 15, wherein a frame exchange between only the non-AP MLD and target AP MLD is performed after a distributed system mapping change and frame exchange context is established.

20. The non-AP MLD of claim 19, wherein the frame exchange context includes for downlink unicast data frame transmission an unallocated maximum sequence number, a WinStart0, block acknowledgement parameters, an unallocated packet number, and a Pairwise Transient Key (PTK).
